(19) United States
(12) Patent Application Publication
(10) Pub. No.: US 2026/0091696 A1
(43) Pub. Date: Apr. 2, 2026

(54) CONTROL SCHEMES FOR VEHICLE-TO-LOAD ELECTRICAL POWER

(71) Applicant: GM GLOBAL TECHNOLOGY OPERATIONS LLC, DETROIT, MI (US)

(72) Inventors: Minh-Khai Nguyen, Troy, MI (US); Lei Hao, Troy, MI (US); Samantha Gunter Miller, Berkley, MI (US); Douglas S. Cesiel, Farmington, MI (US)

(21) Appl. No.: 18/899,256

(22) Filed: Sep. 27, 2024

(51) Int. Cl. B60L 53/22; B60L 53/16

(52) U.S. Cl. CPC B60L 53/22; B60L 53/16; B60L 2210/20; B60L 2250/00

(57) ABSTRACT

Examples described herein provide a circuit that includes a power electronics converter disposed in a vehicle, the power electronics converter to receive alternating current (AC) electrical power from an AC grid source and to provide AC electrical power to an AC load external to the vehicle, the power electronics converter including an AC-AC converter. The circuit further includes an on-board charging module electrically connected to the power electronics converter and a battery disposed in the vehicle. The circuit further includes a controller to control the power electronics converter and the on-board charging module. The power electronics converter provides vehicle-to-load functionality by providing, to the AC load, AC electric power as an output of at least one of a 120 Vac output or a 240 Vac output.

The subject disclosure relates to vehicles, and in particular to control schemes for vehicle-to-load electrical power.

Modern vehicles (e.g., a car, a motorcycle, a boat, or any other type of automobile) may be equipped with one or more batteries to provide electrical power to various systems of the vehicle. For example, an electric vehicle may include one or more batteries to provide electrical power to one or more electric motors, which provide propulsion to the vehicle. This configuration of vehicle is referred to as a battery electric vehicle (BEV). Other types of vehicles may also be equipped with batteries, such as vehicles with combustion engines, hybrid-electric vehicles, and/or the like, including combinations and/or multiples thereof.

Vehicle to load (V2L) is a technique that transfers electrical power from the vehicle to an electrical load connected to the vehicle. For example, electrical power can be transferred from one or more batteries of the vehicle to a system or device connected to the vehicle that operates using the electrical power from the vehicle. This enables the vehicle to supply electrical power in various situations when electrical power may be unavailable, such as during a power outage, at a location without electrical power (e.g., a campsite, a construction site), and/or the like, including combinations and/or multiples thereof. As an example, a vehicle with V2L capabilities can be used to charge another electric vehicle. As another example, the vehicle can include one or more electrical outlets into which any suitable device can be plugged (e.g., a lamp, a coffee machine, an air compressor, and/or the like, including combinations and/or multiples thereof).

### SUMMARY

In one embodiment, a circuit is provided. The circuit includes a power electronics converter disposed in a vehicle, the power electronics converter to receive alternating current (AC) electrical power from an AC grid source and to provide AC electrical power to an AC load external to the vehicle, the power electronics converter including an AC-AC converter. The circuit further includes an on-board charging module electrically connected to the power electronics converter and a battery disposed in the vehicle. The circuit further includes a controller to control the power electronics converter and the on-board charging module. The power electronics converter provides vehicle-to-load functionality by providing, to the AC load, AC electric power as an output of at least one of a 120 Vac output or a 240 Vac output.

In addition to one or more of the features described herein, or as an alternative, further embodiments of the circuit may include that the controller controls the power electronics converter and the on-board charging module based at least in part on an operating scenario of the vehicle.

In addition to one or more of the features described herein, or as an alternative, further embodiments of the circuit may include that the operating scenario is one of no power flow through a charging port of the vehicle, output of 120 Vac through the charging port of the vehicle, or output of 240 Vac through the charging port of the vehicle.

In addition to one or more of the features described herein, or as an alternative, further embodiments of the circuit may include that the operating scenario is charging the battery at 120 Vac or charging the battery at 240 Vac.

In addition to one or more of the features described herein, or as an alternative, further embodiments of the circuit may include that the controller controls the power electronics converter and the on-board charging module based at least in part on a current limit of the AC grid source, an outlet status of an outlet of the vehicle, and load current information of the AC load.

In addition to one or more of the features described herein, or as an alternative, further embodiments of the circuit may include that the controller dynamically adjusts current commands to the on-board charging module based on real-time monitoring of a load current of the AC load and an outlet status of an outlet of the vehicle.

In addition to one or more of the features described herein, or as an alternative, further embodiments of the circuit may include that the controller receives a current limit of the AC grid source via a control pilot line and limits total current from a charge port of the vehicle from exceeding the current limit to prevent the AC grid source from shutting down.

In addition to one or more of the features described herein, or as an alternative, further embodiments of the circuit may include that the output is a split-phase output offering access to both 120 Vac and 240 Vac.

In addition to one or more of the features described herein, or as an alternative, further embodiments of the circuit may include that the controller provides feedback to a human-machine interface to inform a user associated with the vehicle about a current power distribution status of the power electronics converter and the on-board charging module.

In another embodiment, a vehicle is provided. The vehicle includes a battery and a power electronics converter disposed in the vehicle. The power electronics converter receives alternating current (AC) electrical power from an AC grid source and provides AC electrical power to an AC load external to the vehicle and to the battery, the power electronics converter including an AC-AC converter, the AC-AC converter being a multiphase interleaved AC-AC converter. The vehicle further includes an on-board charging module electrically connected to the power electronics converter and the battery disposed in the vehicle. The vehicle further includes a controller to control the power electronics converter and the on-board charging module. The power electronics converter provides vehicle-to-load functionality by providing, to the AC load, AC electric power as an output of at least one of a 120 Vac output or a 240 Vac output.

In addition to one or more of the features described herein, or as an alternative, further embodiments of the vehicle may include that the controller controls the power electronics converter and the on-board charging module based at least in part on an operating scenario of the vehicle.

In addition to one or more of the features described herein, or as an alternative, further embodiments of the vehicle may include that the operating scenario is one of no power flow through a charging port of the vehicle, output of 120 Vac through the charging port of the vehicle, or output of 240 Vac through the charging port of the vehicle.

In addition to one or more of the features described herein, or as an alternative, further embodiments of the vehicle may include that the operating scenario is charging the battery at 120 Vac or charging the battery at 240 Vac.

In addition to one or more of the features described herein, or as an alternative, further embodiments of the vehicle may include that the controller controls the power electronics converter and the on-board charging module based at least in part on a current limit of the AC grid source, an outlet status of an outlet of the vehicle, and load current information of the AC load.

In addition to one or more of the features described herein, or as an alternative, further embodiments of the vehicle may include that the controller dynamically adjusts current commands to the on-board charging module based on real-time monitoring of a load current of the AC load and an outlet status of an outlet of the vehicle.

In addition to one or more of the features described herein, or as an alternative, further embodiments of the vehicle may include that the controller receives a current limit of the AC grid source via a control pilot line and limits total current from a charge port of the vehicle from exceeding the current limit to prevent the AC grid source from shutting down.

In addition to one or more of the features described herein, or as an alternative, further embodiments of the vehicle may include that the output is a split-phase output offering access to both 120 Vac and 240 Vac.

In addition to one or more of the features described herein, or as an alternative, further embodiments of the vehicle may include that the controller provides feedback to a human-machine interface to inform a user associated with the vehicle about a current power distribution status of the power electronics converter and the on-board charging module.

In another embodiment a system is provided. The system includes a power electronics converter disposed in a vehicle, the power electronics converter to receive alternating current (AC) electrical power from an AC grid source and to provide AC electrical power to an AC load external to the vehicle. The system further includes an on-board charging module electrically connected to the power electronics converter and a battery disposed in the vehicle. The system further includes a controller to control the power electronics converter and the on-board charging module based at least in part on a current limit of the AC grid source, an outlet status of an outlet of the vehicle, and load current information of the AC load. The power electronics converter provides vehicle-to-load functionality by providing, to the AC load, AC electric power as an output of at least one of a 120 Vac output or a 240 Vac output.

In addition to one or more of the features described herein, or as an alternative, further embodiments of the system may include that the controller receives the current limit of the AC grid source via a control pilot line and limits total current from a charge port of the vehicle from exceeding the current limit to prevent the AC grid source from shutting down.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a vehicle having a power electronics converter for providing V2L electrical power according to one or more embodiments;

FIG. 2 is a block diagram of a circuit for providing V2L electrical power according to one or more embodiments;

FIG. 3A is a block diagram of a circuit for providing V2L electrical power according to one or more embodiments;

FIG. 3B is a block diagram of a circuit for providing V2L electrical power according to one or more embodiments;

FIG. 4 is a flow diagram of a method for managing the flow of alternating current (AC) power in a vehicle equipped with a power electronics converter according to one or more embodiments;

FIG. 5 is a flow diagram of a method for managing the flow of AC power in a vehicle equipped with a power electronics converter according to one or more embodiments; and

FIG. 6 is a flow diagram of a method for managing the flow of AC power in a vehicle equipped with a power electronics converter according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein provides an architecture that utilizes a power electronics converter having an alternating current (AC)-AC converter to provide 120 Vac and/or 240 Vac to a load electrically connected to a vehicle while the vehicle is charging, idling, or in motion. As used throughout this disclosure, that references to 120 Vac refer to substantially 120 Vac (e.g., 120 Vac+/− some tolerance or variation); similarly, references to 240 Vac refer to substantially 240 Vac (e.g., 240 Vac+/− some tolerance or variation). According to one or more embodiments, one or more embodiments described herein may be implemented at other voltage levels, such as 220 Vac, 230 Vac, and/or the like, including combinations and/or multiples thereof.

The propulsion systems of electric vehicles (EVs) and plug-in hybrid electric vehicles (PHEVs) use an onboard charging module (OBCM) to charge a battery of the vehicle from the electrical grid. In such cases, the electrical grid provides alternating current (AC) electrical power to the vehicle. To discharge the electrical power to electrical outlets on board the vehicle, many vehicles include a standalone direct current (DC) to AC inverter, which may include similar circuitry to what would already be in an OBCM, such as filtering components, an isolation transformer, and multiple stages of power conversion. In many cases, these duplicate subcomponents, such as direct current (DC)-link capacitors or transformers, increase the complexity, size, and weight of the vehicle. This typical approach includes drawbacks, such as being relatively larger in size, being relatively heaver in weight, and/or having a relatively shorter lifetime as compared to one or more of the embodiments described herein.

One or more embodiments described herein address these and other shortcomings by providing a power electronics converter having an AC-AC converter for supplying AC electrical power to one or more devices electrically connected to a vehicle. In many cases, the proposed AC-AC converter can be used with an existing OBCM to provide V2L functionality with minimal hardware additions and controls impact to the OBCM, especially if the OBCM is already bi-directional. According to one or more embodiments, the power electronics converter with AC-AC converter, as described herein, can provide AC power at both 120 Vac and 240 Vac while the vehicle is charging using either AC electrical power or DC electrical power, while the vehicle is parked, or while the vehicle is in operation (e.g., being driven). According to one or more embodiments, the power electronics AC-AC converter, as described herein, can directly transfer electrical power from an electrical grid to both a 120 Vac load and a 240 Vac load while the vehicle is plugged into the electrical grid. One or more embodiments described herein can be implemented in a vehicle or can be used in off-vehicle applications.

According to one or more embodiments, the power electronics converter uses a single-stage non-isolated AC-AC converter that provides 120 Vac and 240 Vac electronic power. Such a device is relatively lower in cost, complexity, and size than existing approaches to V2L. According to one or more embodiments, the OBCM provides galvanic isolation between a battery of the vehicle and the external AC load (e.g., the device plugged into the vehicle). According to one or more embodiments, AC-AC power conversion can be performed directly from the grid and maintain the desired split-phase output if the input is 120 Vac or 240 Vac, where existing autotransformers are designed for one nominal input voltage, such as 240 Vac. According to one or more embodiments, the output of the power electronics AC-AC converter is a stable voltage, even when the AC grid supplying electrical power to the vehicle is disrupted or otherwise experiences a disturbance. According to one or more embodiments, the power electronics AC-AC converter can be used to supply AC electrical power to a structure, such as a house or commercial building, using vehicle-to-home (V2H) via the OBCM. One or more of the embodiments described herein can function independently without interference with the OBCM and its native functions. Other advantages are also possible.

It should be appreciated that the functioning of any vehicle implementing one or more of the embodiments described herein is improved. More particularly, by implementing the power electronics converter having a relay matrix and an AC-AC converter, as described herein, a vehicle can provide V2L functionality without the added complexity of a DC-link capacitor or transformer.

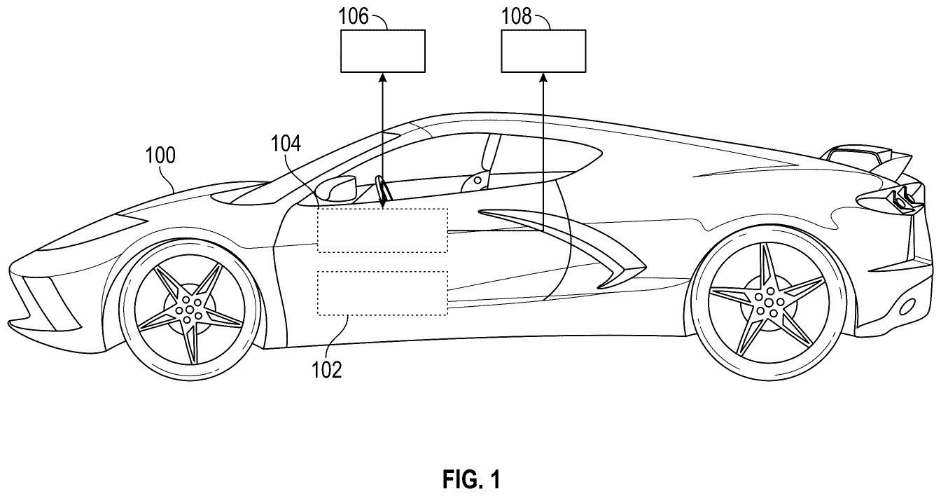

FIG. 1 is an illustration of a vehicle 100 having a power electronics converter for providing V2L electrical power according to one or more embodiments. In this example, the vehicle 100 includes a battery 102 and a power electronics converter 104. In various embodiments, the vehicle 100 includes other components, which are not shown.

The battery 102 can represent one or more batteries such that the vehicle 100 can include a single battery, multiple batteries, a battery system, and/or the like, including combinations and/or multiples thereof. The battery 102 receives electrical power (e.g., from AC grid 106, from an alternator or generator of the vehicle, and/or the like, including combinations and/or multiples thereof). According to one or more embodiments, the electrical power that is received is AC electrical power. The AC grid 106 (also referred to as an “AC grid source”) represents any suitable source of incoming electrical power. For example, the AC grid 106 can be an electrical grid designed to generate and distribute electrical power. In such cases, the vehicle 100 can be electrically connected to a charging station (not shown), which is in turn electrically connected to an electrical grid.

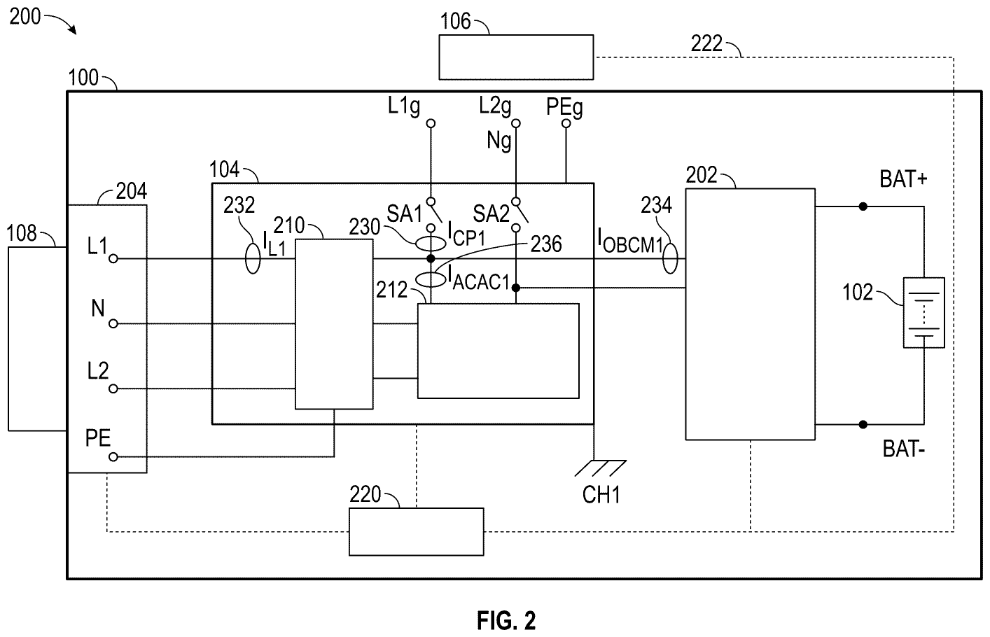

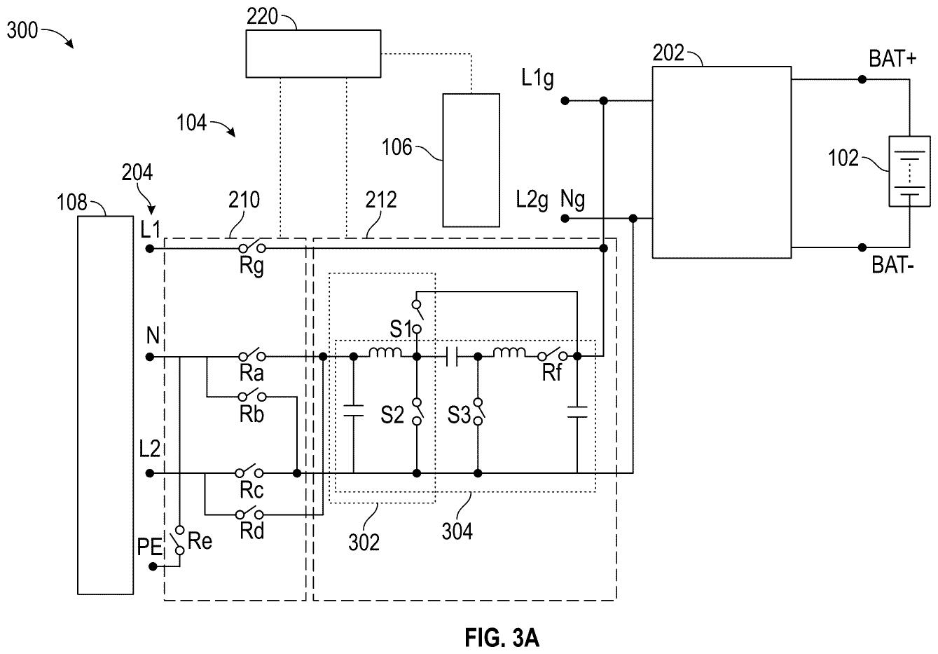

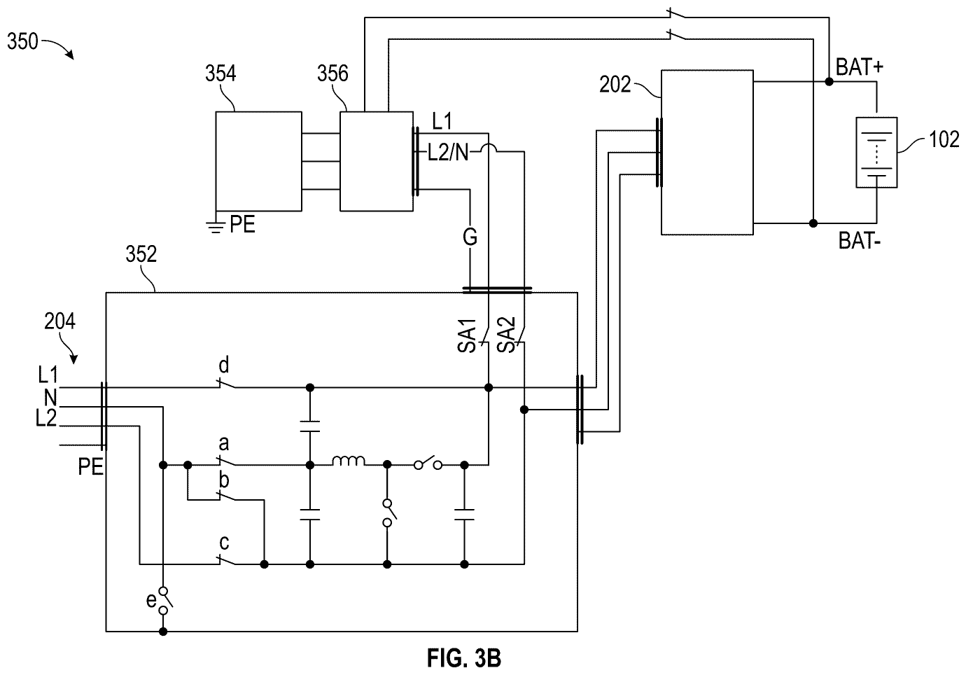

The power electronics converter 104 provides for an architecture that utilizes an AC-AC converter and relay matrix (both shown in FIGS. 2 and 3) to provide 120 Vac and/or 240 Vac to an electrical load (e.g., AC load 108) while the vehicle 100 is charging and/or while the vehicle 100 is in motion or idling. The power electronics converter 104 is an alternating current-based device in that the power electronics converter 104 receives and transmits AC electrical power.

The vehicle 100 can be a car, a truck, a van, a bus, a motorcycle, a boat, or any other type of automobile. According to an embodiment, the vehicle 100 includes an internal combustion engine fueled by gasoline, diesel, or the like. According to another embodiment, the vehicle 100 is a hybrid electric vehicle partially or wholly powered by electrical power along with an internal combustion engine. According to another embodiment, the vehicle 100 is a battery electric vehicle powered by electrical power supplied by a battery. In the example of FIG. 1, the vehicle 100 includes the battery 102, which is used to supply electrical power to an electric motor (not shown) to provide propulsion to the vehicle 100, to supply electrical power to one or more internal systems of the vehicle (e.g., an infotainment system, a climate control system, and/or the like, including combinations and/or multiples thereof), and/or to supply electrical power to a system or device (e.g., the AC load 108) external to the vehicle 100. For example, a system or device (represented as the AC load 108 in FIG. 1) can be connected to the vehicle 100. In such cases, the vehicle 100 supplies electrical power to the AC load 108 using the power electronics converter 104. The electrical power can be supplied to the AC load 108 from the battery 102 and/or from the AC grid 106.

FIG. 2 is a block diagram of a circuit 200 for providing V2L electrical power according to one or more embodiments. The circuit 200 includes the battery 102, the power electronics converter 104, a bi-directional OBCM 202, and an outlet 204. The AC load 108 can electrically connect to the outlet 204. The AC grid 106 can electrically connect to the power electronics converter 104. The power electronics converter 104 includes a relay matrix 210.

The circuit 200 can support several different ways of power flow depending on the operating mode of the vehicle. For example, while the vehicle 100 is in a charging mode (e.g., while the vehicle 100 is receiving electrical power from the AC grid 106 or another suitable source, referred to as an “external charger”), electrical power flows from the AC grid 106 to the battery 102 via the OBCM 202. The OBCM 202 provides isolation between the AC grid 106 and the battery 102. As another example, when the vehicle 100 is in a V2L mode and the vehicle is receiving electrical power from the AC grid 106 or another suitable source, electrical power flows from the AC grid 106 to the AC load 108 via the AC-AC converter 212 and the relay matrix 210. In this mode, the external charger might be providing a lower power than what the AC load 108 wants to draw (e.g., 120 Vac portable EV chargers only provide ˜1 kW, while the AC load 108 might draw more). In this scenario, the OBCM 202 can supplement the power from the AC grid 106 by converting additional power from the battery 102. As yet another example, when the vehicle 100 is in a V2L mode and the vehicle is not receiving electrical power from the AC grid 106 or another suitable source, electrical power flows from the battery 102 to the AC load 108 via the OBCM 202, the AC-AC converter 212, and the relay matrix 210. This situation may include where DC-based fast charging is being performed or while the vehicle 100 is parked or in motion. As yet another example, when the vehicle 100 is in the AC charging mode (e.g., while the vehicle 100 is receiving electrical power from the AC grid 106 or another suitable source), electrical power flows from the AC grid 106 to the battery 102 via the OBCM 202 and from the AC grid 106 to the AC load 108 via the AC-AC converter 212 and the relay matrix 210. In this situation, total power from the AC grid 106 should not exceed a limit of the external charger, so the vehicle 100 can ensure that the total power going to the AC load 108 plus the total power going to the battery 102 is within the limit of the external charger. As yet another example, when the vehicle 100 is operating in a vehicle-to-vehicle (V2V) mode (e.g., the vehicle 100 is providing AC electrical power to another vehicle (not shown)), electrical power flows from the battery 102 to the other vehicle via the OBCM 202 and a charge port (not shown) to which an external charger can connect and/or from the battery 102 to the other vehicle via the OBCM 202, the AC-AC converter 212, the relay matrix 210, and the outlet 204.

The relay matrix 210 includes relays that can be selectively enabled (e.g., closed) and disabled (e.g., opened) according to a desired mode of operation of the circuit 200. The relays of the relay matrix 210 can be selectively enabled/disabled based on a voltage of the AC grid 106, for example. According to one or more embodiments, the relay matrix 210 determines the neutral connection based on the voltage of the AC grid 106. The relay matrix 210 is shown in more detail in FIG. 3A and is described further herein.

The power electronics converter 104 also includes an AC-AC converter 212. The AC-AC converter 212 includes various components for providing a split-phase output, such as 120 Vac electrical power and 240 Vac electrical power, which are shown in more detail in FIG. 3A and are described further herein. It should be appreciated that the AC-AC converter 212 can be any suitable type of converter or combination of converters that provide the appropriate voltage magnitude and phase for each output. For example, the AC-AC converter 212 can be a direct AC-AC converter, such as a buck converter, a boost converter, a buck-boost converter, a Ćuk converter, indirect AC-AC converter such as Back-to-back DC link based AC-AC power converter, back-to-back AC link-based AC-AC power converter, and/or the like, including combinations and/or multiples thereof. Depending on power outlet voltage requirement, a suitable AC-AC converter will be selected. For example, if the outlet voltage of 240 Vac is not needed during level 1 charging, the Cuk converter 304 can be removed. Moreover, a multiphase interleaved AC-AC converter can be used for high power implementations.

Referring to FIG. 2, AC electrical power is provided to the vehicle 100 by the AC grid 106 at L1g, L2g/Ng, and PEg (collectively referred to as the “charge port”) as shown, where PEg refers to the protective earth of the AC grid 106. In particular, the AC grid 106 can be connected to the power electronics converter 104, which distributes the electrical power to one or more of the battery 102 via the OBCM 202 and/or to the AC load 108 via the AC-AC converter 212 and relay matrix 210 as shown. Two switches, SA1 and SA2, can selectively enable and disable the connection between the AC grid 106 and the AC-AC converter 212 and the OBCM 202 based on what is plugged in at the charge port (e.g., at L1g, L2g/Ng, and PEg). For example, if the AC grid 106 is plugged into the charge port, the switches SA1 and SA2 are enabled (e.g., closed). In some cases, it is desirable to disable (e.g., open) one or more of the switches SA1 and SA2, such as if the vehicle 100 is performing DC fast charging or if nothing is connected to the charge port. Two switches are provided for redundancy, which may reduce the likelihood of failure in the event one of the switches becomes stuck/welded closed; however, in other embodiments, the number of switches can be reduced and/or the switches can be eliminated entirely. To ensure each switch SA1 and SA2 is in the intended state (e.g., open or closed), there can be accompanying sensing circuitry and diagnostic control according to one or more embodiments.

The AC load 108 connects to the outlet 204 at L1, N, L2, and PE as shown. In one embodiment, L1 is connected directly to the OBCM 202 via relay Rg in the relay matrix 210 (as shown in FIG. 3A), and N, L2, and PE (protective earth) are connected to the relay matrix 210 as shown. According to one or more embodiments, L1 and N can together provide 120 Vac to the AC load 108 while L2 and N can together provide 120 Vac to another AC load (not shown). In this case, the two 120 Vac supplies to the AC loads are out of phase relative to one another (e.g., the 120 Vac supplied by L2/N is out of phase relative to the 120 Vac supplied by L1/N), thereby providing 240 Vac by L1/L2.

Different scenarios for providing AC electrical power to the AC load 108 are now described with reference to FIG. 3A, which also shows more detail of aspects of the power electronics converter 104. In particular, FIG. 3A is a block diagram of a circuit 300 for providing V2L electrical power according to one or more embodiments. In the example of FIG. 3A, the relay matrix 210 and the AC-AC converter 212 of the power electronics converter 104 are shown in more detail.

The relay matrix 210 includes five relays configured and arranged as shown, including relays Ra, Rb, Rc, Rd, Re, and Rg. The relays Ra-Re, Rg can be selectively enabled (e.g., closed) and disabled (e.g., opened) depending on different scenarios, which are described herein. To ensure each relay Ra-Re and Rg is in the intended state (e.g., open or closed), there can be accompanying sensing circuitry and diagnostic control according to one or more embodiments.

The AC-AC converter 212 includes a buck converter 302 and a Ćuk converter 304, which together provide split-phase 120 Vac. The buck converter 302 includes switches S1 and S2, among other components (e.g., a capacitor and an inductor). The Cuk converter 304 includes relay Rf and switches S2 and S3, among other components (e.g., capacitors and inductors as shown). Together, the buck converter 302 and the Cuk converter 304 enable the AC-AC converter 212 to provide split-phase 120 Vac and/or 240 Vac to the AC load 108. Depending on power outlet voltage requirement, a suitable AC-AC converter will be selected. For example, if the outlet voltage of 240 Vac is not needed during level 1 charging, the Cuk converter 304 can be removed. Moreover, a multiphase interleaved AC-AC converter can be used for high power implementations.

As described above, the relays Ra-Re, Rg of the relay matrix 210 and the switches S1-S3 and relay Rf of the AC-AC converter 212 can be configured differently depending on different scenarios, which are now described. In a first scenario, the vehicle 100 is connected to AC grid 106 at L1g and L2g/Ng as shown in FIGS. 2 and 3 and is receiving 120 Vac. In this scenario, relays Rb, Rd, Rg, and Rf of the power electronics converter 104 are enabled (e.g., closed), and the relays Ra and Rc are disabled (e.g., open); switch S1 is disabled (e.g., open), and the switches S2 and S3 are controlled in high frequency pulse width modulation (PWM) to achieve the Cuk converter 304 function. As a result of this configuration of relays and switches, the output of the Cuk converter 304 across L2/N is 120 Vac and out-of-phase with L1/N at the outlet 204.

In a second scenario, the vehicle 100 is connected to AC grid 106 at L1g and L2g/Ng as shown in FIGS. 2 and 3 and is receiving 240 Vac. In this scenario, the relays Ra, Rc, and Rg are enabled (e.g., closed), and the relays Rb, Rd, and Rf are disabled (e.g., open); switch S3 is disabled (e.g., open), and the switches S1 and S2 are controlled in high frequency PWM to achieve the buck converter 302 function. As a result of this configuration of relays and switches, the output of the buck converter 302 is reduced from 240 Vac (e.g., from the AC grid 106) to 120 Vac across L2/N at the outlet 204. 240 Vac is still maintained across L1/L2 and 120 Vac is created across L1/N, thereby providing the desired split-phase output at the outlet 204.

In a third scenario, the vehicle 100 is not connected to AC grid 106 in what is referred to as an “off-grid” scenario. In this scenario, the OBCM 202 discharges the battery 102 at 240 Vac. The relays Ra, Rc, and Rg are enabled (e.g., closed), and the relays Rb, Rd, and Rf are disabled (e.g., open); switch S3 is disabled (e.g., open), and the switches S1 and S2 are controlled in high frequency PWM to achieve the buck converter 302 function. As a result of this configuration of relays and switches, the output of the buck converter 302 is reduced from 240 Vac (e.g., from the OBCM 202) to 120 Vac across L2/N at the outlet 204. 240 Vac is still maintained across L1/L2 and 120 Vac is created across L1/N, thereby providing the desired split-phase output at the outlet 204.

According to an embodiment, the relatively high frequency PWM may be 20-250 kHz, although other frequencies may be used in other embodiments. The switches S1-S3 can be bi-directional switches with insulated-gate bipolar transistors (IGBT), metal-oxide-semiconductor field-effect transistor (MOSFET) based on silicon (Si), silicon carbide (SiC), and/or gallium nitride (GaN), and/or the like, including combinations and/or multiples thereof.

According to one or more embodiments, the relay Re of the relay matrix 210 can be selectively enabled (e.g., closed) and disabled (e.g., open) depending on the situation in which the vehicle 100 is providing the electrical power. For example, the relay Re is closed for V2L to power plug-and-cord connected loads, similar to a bonded neutral generator. As another example, the relay Re is open for V2H to power a house or other similar structure, similar to a floating neutral generator.

In the embodiments of FIGS. 2 and 3, the power electronics converter 104 utilizes the AC-AC converter 212 to provide 120 Vac and/or 240 Vac to the AC load 108 while the vehicle 100 is charging, in motion, or idle. In some cases, it may be desirable ensure that current limits are not violated under various operating conditions, which can be challenging, leading to potential shutdowns of the external electric vehicle supply equipment (EVSE) (e.g., an EV charger).

One or more embodiments described herein addresses these and other shortcomings by incorporating a controller (e.g., the controller 220) that facilitates the control of the power electronics converter 104 (including the AC-AC converter 212) and the OBCM 202 based on different operating scenarios. The controller 220 receives current measurements and outlet status information and issues current commands to the OBCM 202 based on a current limit of the AC grid 106, outlet status of the outlet 204, and load current information of the AC load 108. This coordinated control aids in avoiding violating the current limits of the external EVSE, which is useful for avoiding or preventing shutdowns and improving the overall efficiency and reliability of the power management system of the vehicle 100. Use of the controller 220 minimizes the need for additional hardware, reducing the vehicle's size, weight, and complexity while providing 120 Vac and 240 Vac to the AC load 108 under various conditions, including while the vehicle is charging, in motion, or idle.

The vehicle 100 receives a current limit of the AC grid 106 (e.g., a current limit of an EVSE) via a control pilot (CP) line 222 connecting the AC grid 106 and the controller 220. According to one or more embodiments, the total current from the AC grid 106 at the charge port should not exceed the current limit of the AC grid 106 (referred to as “CP current limit” and denoted I_{CP1,limit}) to prevent the external EVSE from shutting down. The controller 220 senses current (e.g., I_{CP1}) coming from the charge port of the vehicle 100, senses the current going to the AC load 108, and senses the current going to the OBCM 202. As shown in FIG. 2, the controller 220 senses the current (e.g., I_{CP1}) coming from the charge port at current sensor 230, senses the current (e.g., I_{L1}) going to the AC load 108 at current sensor 232, senses the current (e.g., I_{OBCM1}) going to the OBCM 202 at current sensor 234, and senses the current (e.g., I_{ACAC1}) going to the AC-AC converter 212 at current sensor 236. The controller 220 issues current commands, such as indicating a magnitude of charging or discharging, to the OBCM 202. The current commands can be based on the CP current limit, outlet status (e.g., whether the AC load 108 is drawing 120 Vac or 240 Vac), and load current information (e.g., how much current is being drawn by the AC load 108 as measured by the current sensor 232).

According to one or more embodiments, the controller 220 issues the current commands to prevent overloading and overcurrent conditions, such as to prevent the external EVSE from shutting down. To do this, the controller 220 can implement one or more rules based on the sensed currents shown in FIG. 2. Non-limiting examples of such rules are as follows:

$${I}_{CP 1} < {I}_{CP 1 , limit} ,$$

$${I}_{CP 1} = {I}_{L 1} + {I}_{ACAC 1} + {I}_{OBCM 1} ; and$$

$${I}_{OBCM 1} < {I}_{CP 1} - {I}_{L 1} - {I}_{ACAC 1} .$$

In FIG. 2, for simplicity, only L1 current measurements and control is shown, but it should be appreciated that similar architectures and functionality can be applied to L2, N, and PE, for example.

According to one or more embodiments, the controller 220 can be a versatile and sophisticated device designed to manage the power electronics converter and the OBCM in various operating scenarios. The controller 220 can include a microcontroller, a digital signal processor (DSP), a field-programmable gate array (FPGA), and/or the like, including combinations and/or multiples thereof, to execute complex control algorithms in real-time. The controller 220 may also incorporate an ASIC for specialized tasks and/or general-purpose processor(s) for broader functionality. Additionally or alternatively, the controller 220 can include memory components, such as random access memory (RAM) and/or read-only memory (ROM), to store software, firmware, and operational data. The controller 220 can include various input/output interfaces for communication with sensors, actuators, and other vehicle systems, as well as communication modules for interfacing with external devices and networks. The controller 220 may also be equipped with diagnostic and monitoring capabilities to ensure the reliability and efficiency of the vehicle 100 and its various systems as described herein.

Another embodiment a circuit for providing V2L electrical power is now described with reference to FIG. 3B. In particular, FIG. 3B is a block diagram of a circuit 350 for providing V2L electrical power according to one or more embodiments. In this embodiment, a direct AC-AC buck converter 352 is used to convert a high AC voltage, such as 240 Vac, to a low AC voltage, such as 120 Vac. Relays a, c, and d are closed while relay b is opened when the input voltage is connected to 240 Vac (e.g., the EVSE 354) at the charge port 356. In this embodiment, the direct AC-AC buck converter 352 includes three terminals that convert a single 240 Vac input voltage to the split-phase output voltage of 120 Vac on L1-N and another 120 Vac on L2-N but out-of-phase relative to L1-N. Then, L1-L2 output voltage of 240 Vac by-pass from the input voltage. For high power applications, a multiphase interleaved buck converter can be used for efficiency improvement. When the input voltage is connected to the 120 Vac grid for level 1 charging (e.g., the EVSE 354 is provide 120 Vac at the charge port 356), relays b and d are closed to by-pass the input voltage to L1-N output voltage, and relays a, c, and e are opened to disable L2-N output voltage. It should be appreciated that input and output electromagnetic compatibility (EMC) filters (not shown) can be used in the direct AC-AC buck converter 354 to eliminate the high frequency noise according to one or more embodiments.

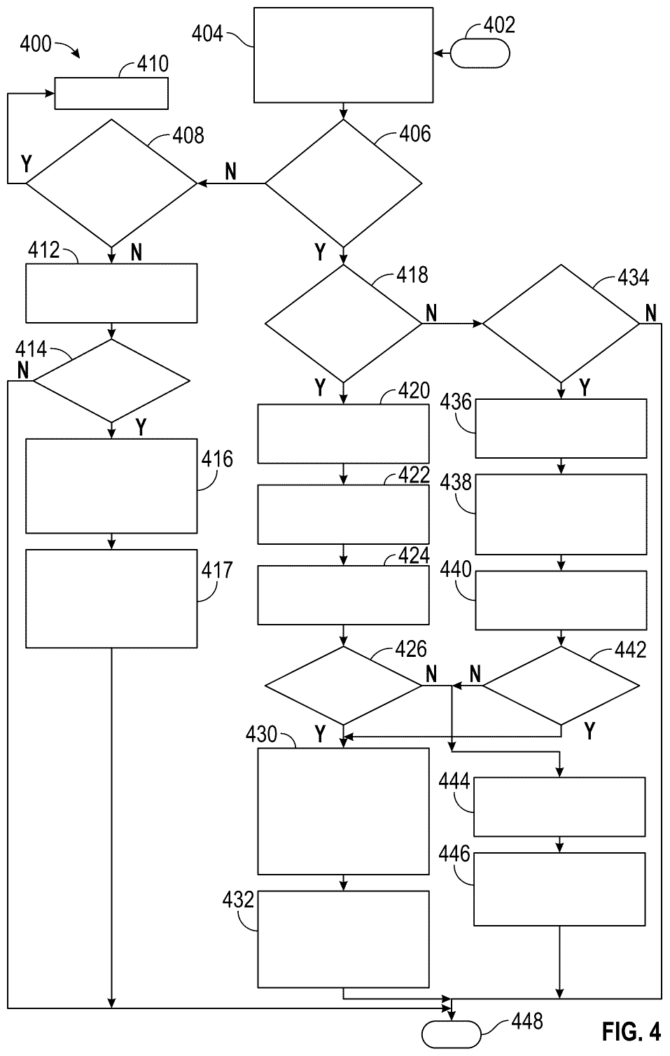

Depending on operating conditions of the vehicle 100, the controller 220 can implement various control schemes to provide desired functionality of the power electronics converter 104. According to one or more embodiments, the more functionality that is desired, the more complex the control algorithm is in order to provide AC power at 120 Vac and 240 Vac at the outlet 204, especially while AC charging due to external constraints and unknowns. The controller 220 can control the power electronics converter and the on-board charging module in various operating scenarios, which are now described in more detail with reference to FIGS. 4, 5, and 6.

With continued reference to FIGS. 2-3B, an example operating scenario is as follows: no power is flowing through the charging port from the AC grid 106 to the vehicle 100 or from the vehicle 100 to the AC grid 106, and the vehicle is driving, idling, or parked or when State-of-Charge (SOC) of the battery 102 is high enough to temporary disconnect the AC grid 106 from the charging port for power outlet providing in some cases. The controller 220 causes switches SA1 and SA2 to open such that no DC voltage is applied to the OBCM 202 or the AC-AC converter 212 and no AC voltage is applied to the charge port. The controller 220 commands the OBCM 202 to provide 240 Vac to provide full power to the AC load 108. The OBCM 202 reduces its current limit based on a desired current limit at the outlet 204. For example, the OBCM 202 reduces its current limit from substantially 80 amps (A) to substantially 50 A to provide overcurrent protection to the outlet 204, which eliminates the need for a 50 A circuit breaker at the outlet 204.

With continued reference to FIGS. 2-3B, another example operating scenario is as follows: AC power is being output from the vehicle 100 to the AC grid 106 via the charging port while the vehicle is parked. In this operating scenario, 240 Vac is being output from the vehicle 100 via the charging port while the vehicle 100 is parked. In this operating scenario, the vehicle 100 may be providing 240 Vac to a vehicle (V2V), to a home (V2H), or to the AC grid 106 (V2G), for example. The controller 220 causes switches SA1 and SA2 to close such that AC voltage is applied to the charge port. The controller 220 causes the OBCM 202 to provide 240 Vac. The OBCM 202 sets its current limit to a maximum allowable current (e.g., substantially 80 A) to provide as much power as possible. For example, substantially 19.2 kilowatts (KW) can be provided to the charge port for V2V, V2H or V2G. In such cases, the AC-AC converter 212 may be equipped with overcurrent protection (e.g., 50 A overcurrent protection), which eliminates the need for a 50 A circuit breaker.

With continued reference to FIGS. 2-3B, another example operating scenario is as follows: 120 Vac power is being output from the vehicle 100 via the charging port while the vehicle is parked. In this operating scenario, the vehicle 100 may be providing 120 Vac to a load (V2L), for example. The controller 220 causes switches SA1 and SA2 to close such that AC voltage is applied to the charge port. The controller 220 causes the OBCM 202 to provide 120 Vac. This reduces the total available power by substantially 50% as compared to 240 Vac. According to one or more embodiments, a user associated with the vehicle can be informed, such as via a human-machine interface (HMI), that power to the outlet 204 is reduced. The OBCM 202 sets its current limit to a maximum allowable current (e.g., substantially 80 A) to provide as much power as possible. In such cases, the AC-AC converter 212 may be equipped with overcurrent protection (e.g., 50 A overcurrent protection), which eliminates the need for a 50 A circuit breaker.

These operating scenarios are further described with reference to FIG. 4. In particular, FIG. 4 illustrates a method 400 for managing the flow of alternating current (AC) power in a vehicle equipped with a power electronics converter according to one or more embodiments. The method 400 can be implemented by any suitable system or device, such as the controller 220. The method 400 represents one possible example of controlling the power electronics converter 104 and the OBCM 202.

The method 400 begins at block 402 and proceeds to block 404. At block 404, the controller 220 reads a vehicle status, outlet status, load information, and control pilot line current limit.

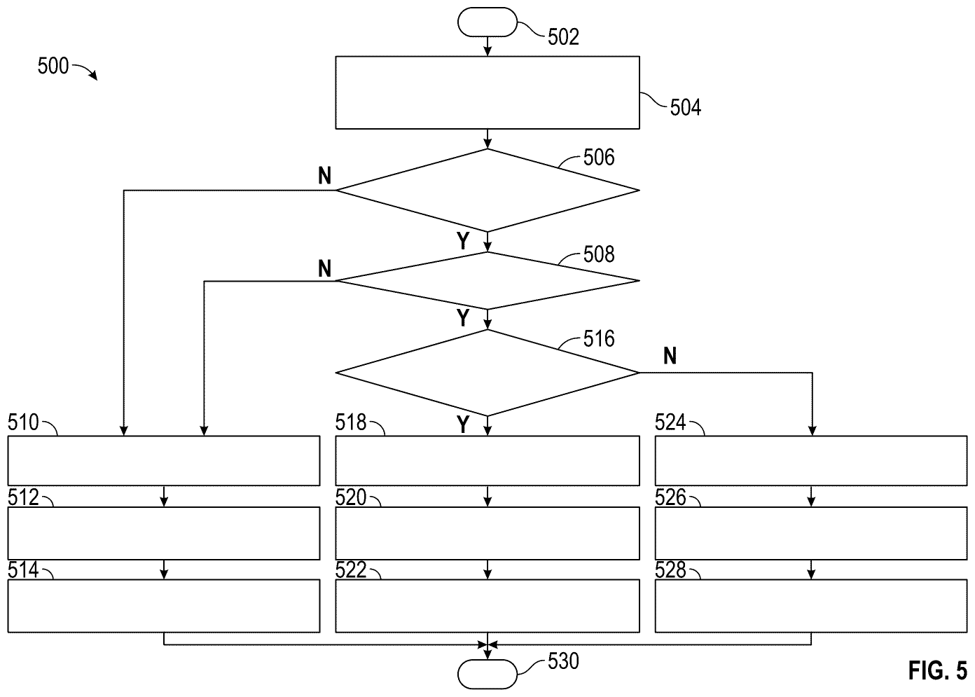

At decision block 406, the controller 220 determines whether AC power is flowing out through the charging port. If the answer is no, the method 400 proceeds to decision block 408, where it is determined whether AC power is flowing in through the charging port. If the answer is yes at decision block 408, the method 500 shown in FIG. 5, and described further herein, is implemented at block 410. If the answer at decision block 408 is no, the method 400 proceeds to block 412.

At block 412, the controller 220 commands that switches SA1 and SA2 are open. The method 400 then proceeds to decision block 414 to check if the vehicle is in vehicle-to-load (V2L) mode through the outlet 204. If the answer is no, the method 400 ends at block 448. If the answer is yes, the method 400 proceeds to block 416.

At block 416, the OBCM 202 is commanded to provide 240V/120V AC and reduce the current limit to 50A. The method 400 then proceeds to decision block 417, where the AC-AC converter 212 generates split phase 240 Vac and 120 Vac. The method 400 then proceeds to block 448 and ends.

If, at decision block 406 it is determined that AC power needs to flow out through the charging port, the method 400 proceeds to decision block 418. At decision block 418, the controller 220 checks if the vehicle 100 is in V2V or V2H mode through the charging port. If the answer is yes, the method 400 proceeds to block 420, where the controller 220 commands switches SA1 and SA2 closed. The method 400 then proceeds to block 422, where the controller 220 commands the OBCM 202 to provide 240 Vac. The method 400 then proceeds to block 424, where the OBCM 202 sets its current limit to substantially 80 A. The method 400 then proceeds to decision block 426.

At decision block 426, the controller 220 checks if the vehicle 100 is in V2L mode and is providing electrical power through the outlet 204. If the answer is yes, the method 400 proceeds to block 430. At block 430, the controller 220 performs AC-AC control of power flowing through to the outlet 204. The method 400 proceeds to block 432, where the output current of the OBCM 202 is controlled by setting the output to I_{OBCM1}=−I_{CP1}+I_{ACAC1}+I_{L1}. In this case, I_{CP1} is negative because the positive current is defined that current is coming from the charging port rather than going into the charging port from the vehicle point of view. The current may be limited, such as to 30 Amps, 50 Amps, and/or the like. The method 400 then ends at block 448.

If the answer is no at decision block 426 or is no at decision block 442, the method 400 proceeds to block 444. At block 444, the controller 220 sets the AC-AC converter 212 to 50A current protection. According to one or more embodiments, at block 444, if there is no V2L through the outlet 204, then the AC-AC converter 212 is disabled so there is no voltage at the outlet 204. The method 400 then proceeds to block 446, where the controller 220 controls the output current of the OBCM 202 by setting the output to I_{OBCM1}=−I_{CP1}. The current sign definition is the same as described above. The method 400 then ends at block 448.

If at decision block 418, the controller 220 determines that the vehicle 100 is not in V2H mode through the charging port, the method 400 proceeds to decision block 434. At decision block 434, the controller 220 checks if the vehicle 100 is in V2L mode through the charging port. If the answer is no, the method 400 ends at block 448. If the answer at decision block 434 is yes, the method 400 proceeds to block 436, where the controller 220 commands the switches SA1 and SA2 closed. The method 400 then proceeds to block 438, where the controller 220 commands the OBCM 202 to provide 120 Vac. The method 400 then proceeds to block 440, where the OBCM 202 sets its current limit to substantially 80 A. The method 400 then proceeds to decision block 442.

At decision block 442, the controller 220 determines if the vehicle is in V2L mode through the outlet 204. If the answer is yes, the method 400 proceeds to block 430. If the answer is no, the method 400 proceeds to block 444.

Additional processes also may be included, and it should be understood that the process depicted in FIG. 4 represents an illustration, and that other processes may be added or existing processes may be removed, modified, or rearranged without departing from the scope of the present disclosure.

With continued reference to FIGS. 2-3B, additional example operating scenarios are now described. An example operating scenario is as follows: input AC power is flowing through the charging port, and AC charging is being performed at 240 Vac and 80 A. In this operating scenario, the vehicle 100 is parked and is receiving 240 Vac from the AC grid 106 via the charging port at 80 A, for example. The controller 220 causes switches SA1 and SA2 to close. The controller 220 causes the OBCM 202 to draw AC current. According to one or more embodiments, the OBCM 202 is controlled to draw AC current at a minimum current threshold (e.g., 30 A) but the exact magnitude of the AC current depends on whether the outlet 204 is enabled, whether the outlet 204 is connected to and being used by the AC load 108, and the magnitude of current being drawn by the AC load 108. The OBCM 202 sets its current limit to a maximum allowable current (e.g., substantially 80 A) to provide as much power as possible. In such cases, the AC-AC converter 212 may be equipped with overcurrent protection (e.g., 50 A overcurrent protection), which eliminates the need for a 50 A circuit breaker.

With continued reference to FIGS. 2-3B, another example operating scenario is as follows: input AC power is flowing through the charging port, and AC charging is being performed at 240 Vac and 32 A. In this operating scenario, the vehicle 100 is parked and is receiving 240 Vac from the AC grid 106 via the charging port at 32 A, for example. The controller 220 causes switches SA and SA2 to close, and AC voltage is applied to the OBCM 202 and the AC-AC converter 212. The controller 220 causes the OBCM 202 to either draw AC current or provide AC current depending on whether the outlet 204 is enabled, whether the outlet 204 is connected to and being used by the AC load 108, and the magnitude of current being drawn by the AC load 108. The OBCM 202 sets its current limit to a maximum allowable current (e.g., substantially 80 A) to provide as much power as possible. In such cases, the AC-AC converter 212 may be equipped with overcurrent protection (e.g., 50 A overcurrent protection), which eliminates the need for a 50 A circuit breaker.

With continued reference to FIGS. 2-3B, another example operating scenario is as follows: input AC power is flowing through the charging port, and AC charging is being performed at 120 Vac and 12 A. In this operating scenario, the vehicle 100 is parked and is receiving 120 Vac from the AC grid 106 via the charging port at 12 A, for example. The controller 220 causes switches SA1 and SA2 to close, and AC voltage is applied to the OBCM 202 and the AC-AC converter 212. The controller 220 disables the outlet 204, such as by opening a switch (not shown) on the line to L1. In such cases, a user associated with the vehicle can be informed, such as via a HMI, that power to the outlet 204 is unavailable. The controller 220 causes the OBCM 202 to draw AC current. The OBCM 202 can reduce its current limit as desired, and the AC-AC converter 212 may be equipped with overcurrent protection (e.g., 50 A overcurrent protection), which eliminates the need for a 50 A circuit breaker.

With continued reference to FIGS. 2-3B, in another operating scenario, the user, via the HMI, can select whether to implement the immediately prior operating scenario or the following operating scenario where input AC power is flowing through the charging port, and AC charging is being performed at 120 Vac and 12 A, but V2L is not supported or enabled. In this operating scenario, the controller 220 causes switches SA1 and SA2 to close. AC voltage is applied to the OBCM 202 and the AC-AC converter 212. The controller 220 informs, via the HMI, the user that the outlet 204 is unavailable. The controller 220 causes the OBCM 202 to draw AC current. In such cases, the AC-AC converter 212 may be equipped with overcurrent protection (e.g., 50 A overcurrent protection), which eliminates the need for a 50 A circuit breaker.

With continued reference to FIGS. 2-3B, another example operating scenario is as follows: input AC power is flowing through the charging port, and AC charging is being performed at 120 Vac and 12 A, and V2L is supported and enabled. In this operating scenario, the vehicle 100 is parked and is receiving 120 Vac from the AC grid 106 via the charging port at 12 A, for example. The controller 220 causes switches SA1 and SA2 to close, and AC voltage is applied to the OBCM 202 and the AC-AC converter 212. The controller 220 commands the OBCM 202 to provide AC current, where the total available power is reduced (e.g., 19.2 kW is reduced to 9.6 kW+1.4 kW=11 kW). The user can be informed, via the HMI, that power to the outlets and reduced and the battery 102 will not be charged. The OBCM 202 can reduce its current limit as desired, and the AC-AC converter 212 may be equipped with overcurrent protection (e.g., 50 A overcurrent protection), which eliminates the need for a 50 A circuit breaker.

These operating scenarios are further described with reference to FIG. 5. In particular, FIG. 5 illustrates a method 500 for managing the flow of alternating current (AC) power in a vehicle equipped with a power electronics converter according to one or more embodiments. The method 500 can be implemented by any suitable system or device, such as the controller 220. The method 500 represents one possible example of controlling the power electronics converter 104 and the OBCM 202.

The method 500 begins at block 502 and proceeds to block 504. At block 504, the controller 220 reads vehicle status, outlet status, load information, and control pilot line current limit.

At decision block 506, the controller 220 determines whether AC power is flowing through the charging port. If the answer is no, the method 500 proceeds to block 510. If the answer is yes, the method 500 proceeds to decision block 508, where the controller 220 determines whether V2L is desired. If the answer is no, the method 500 proceeds to block 510, where the controller 220 commands switches SA1 and SA2 closed. The method 500 then proceeds to block 512, where the OBCM 202 control charging current is set to I_{OBCM1}=I_{CP1}. The method 500 then proceeds to block 514, where the AC-AC converter 212 is set to 50 A current protection. The method 500 then ends at block 530.

If the answer at decision block 508 is yes, the method 500 proceeds to decision block 516, the controller 220 checks if the input power is greater than the outlet load power. If the answer is yes, the method 500 proceeds to block 518, where the controller 220 commands switches SA1 and SA2 closed. The method 500 then proceeds to block 520, where the controller 220 commands the AC-AC converter 212 to provide load power. The method 500 then proceeds to block 522, where the OBCM 202 control charging current is set to I_{OBCM1}=I_{CP1}−I_{ACAC1}−I_{L1}. The method 500 then ends at block 530.

If the answer at decision block 516 is no, the method 500 proceeds to block 524, where the controller 220 commands switches SA1 and SA2 closed. The method 500 then proceeds to block 526, where the OBCM 202 is commanded to provide output power I_{OBCM1}=I_{L1}+I_{ACAC1}−I_{CP1}. The method 500 then proceeds to block 528, where the AC-AC converter 212 controls the current to the AC load 108. The method 500 then ends at block 530.

Additional processes also may be included, and it should be understood that the process depicted in FIG. 5 represents an illustration, and that other processes may be added or existing processes may be removed, modified, or rearranged without departing from the scope of the present disclosure.

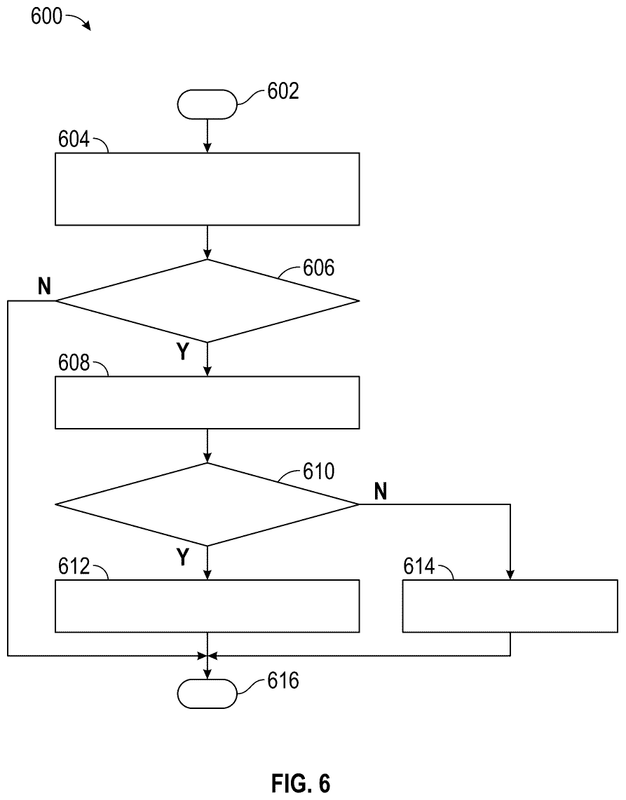

FIG. 6 illustrates a method 600 for managing the flow of alternating current (AC) power in a vehicle equipped with a power electronics converter according to one or more embodiments in the AC charging mode. The method 600 can be implemented by any suitable system or device, such as the controller 220. The method 600 represents one possible example of controlling the power electronics converter 104 and the OBCM 202.

The method 600 begins at block 602 and proceeds to block 604. At block 604, the controller 220 reads the vehicle status, outlet status, load information, and control pilot line current limit. If a lid (not shown) of the outlet 204 is open as determined at decision block 606, the current of AC-AC converter 212 is limited by an amount of current, such as 20 Amps, at block 608. Then, at decision block 610, it is determined whether the total load current (I_{L1}+I_{ACAC1}) is greater than an amount of current (xA) (e.g., 10 Amps). If so (decision block 610 “Yes”), the OBCM command current (I_{OBCM1}) is set to I_{CP1}−I_{L1}−I_{ACAC1}−I_{margin} at block 612, where I_{margin} is a margin current to ensure the EVSE is not over current when an inrush current appears at the load side of the outlet 204. If not (decision block 610 “No”), the OBCM command current (I_{OBCM1}) is set, at block 614, to I_{CP1}−I_{L1}−I_{ACAC1}. The method 600 terminates at block 616.

Additional processes also may be included, and it should be understood that the process depicted in FIG. 6 represents an illustration, and that other processes may be added or existing processes may be removed, modified, or rearranged without departing from the scope of the present disclosure.

The controller 220 significantly improves the functioning of the vehicle 100 by providing precise and dynamic management of the OBCM 202 and the power electronics converter 104. By receiving real-time data on vehicle status, outlet status, load information, and control pilot line current limits, the controller 220 can issue optimized current commands to the OBCM 202, ensuring efficient power distribution and preventing overloading and overcurrent conditions. This coordinated control helps maintain the current limits of the EVSE, thereby avoiding shutdowns and enhancing the overall reliability of the power management system.

Furthermore, the ability of the controller 220 to dynamically adjust the operation of the AC-AC converter, including the switching operations of buck and Cuk converters, ensures that the vehicle 100 can provide stable and split-phase AC power (120 Vac and 240 Vac) to external loads under various conditions, such as while charging, idling, or in motion. The controller 220 also manages the relay matrix, selectively enabling or disabling relays based on the operating scenario of the vehicle 100 to ensure proper voltage and current distribution.

Additionally, the controller 220 can implement different control algorithms based on customer preferences or specific vehicle program requirements, such as disabling outlets or prioritizing certain loads. The controller 220 also provides feedback to a HMI, informing a user associated with the vehicle 100 about the current power distribution status, any limitations due to power constraints, and the operational mode of the vehicle 100. Overall, the controller 220 enhances the vehicle's efficiency, reliability, and user experience by optimizing the performance of the OBCM and the power electronics converter.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A circuit comprising:
a power electronics converter disposed in a vehicle, the power electronics converter to receive alternating current (AC) electrical power from an AC grid source and to provide AC electrical power to an AC load external to the vehicle, the power electronics converter comprising an AC-AC converter;
an on-board charging module electrically connected to the power electronics converter and a battery disposed in the vehicle; and
a controller to control the power electronics converter and the on-board charging module,
wherein the power electronics converter provides vehicle-to-load functionality by providing, to the AC load, AC electric power as an output of at least one of a 120 Vac output or a 240 Vac output.

2. The circuit of claim 1, wherein the controller controls the power electronics converter and the on-board charging module based at least in part on an operating scenario of the vehicle.

3. The circuit of claim 2, wherein the operating scenario is one of no power flow through a charging port of the vehicle, output of 120 Vac through the charging port of the vehicle, or output of 240 Vac through the charging port of the vehicle.

4. The circuit of claim 2, wherein the operating scenario is charging the battery at 120 Vac or charging the battery at 240 Vac.

5. The circuit of claim 1, wherein the controller controls the power electronics converter and the on-board charging module based at least in part on a current limit of the AC grid source, an outlet status of an outlet of the vehicle, and load current information of the AC load.

6. The circuit of claim 1, wherein the controller dynamically adjusts current commands to the on-board charging module based on real-time monitoring of a load current of the AC load and an outlet status of an outlet of the vehicle.

7. The circuit of claim 1, wherein the controller receives a current limit of the AC grid source via a control pilot line and limits total current from a charge port of the vehicle from exceeding the current limit to prevent the AC grid source from shutting down.

8. The circuit of claim 1, wherein the output is a split-phase output offering access to both 120 Vac and 240 Vac.

9. The circuit of claim 1, wherein the controller provides feedback to a human-machine interface to inform a user associated with the vehicle about a current power distribution status of the power electronics converter and the on-board charging module.

10. A vehicle comprising:
a battery;
a power electronics converter disposed in the vehicle, the power electronics converter to receive alternating current (AC) electrical power from an AC grid source and to provide AC electrical power to an AC load external to the vehicle and to the battery, the power electronics converter comprising an AC-AC converter, the AC-AC converter being a multiphase interleaved AC-AC converter;
an on-board charging module electrically connected to the power electronics converter and the battery disposed in the vehicle; and
a controller to control the power electronics converter and the on-board charging module,
wherein the power electronics converter provides vehicle-to-load functionality by providing, to the AC load, AC electric power as an output of at least one of a 120 Vac output or a 240 Vac output.

11. The vehicle of claim 10, wherein the controller controls the power electronics converter and the on-board charging module based at least in part on an operating scenario of the vehicle.

12. The vehicle of claim 11, wherein the operating scenario is one of no power flow through a charging port of the vehicle, output of 120 Vac through the charging port of the vehicle, or output of 240 Vac through the charging port of the vehicle.

13. The vehicle of claim 11, wherein the operating scenario is charging the battery at 120 Vac or charging the battery at 240 Vac.

14. The vehicle of claim 10, wherein the controller controls the power electronics converter and the on-board charging module based at least in part on a current limit of the AC grid source, an outlet status of an outlet of the vehicle, and load current information of the AC load.

15. The vehicle of claim 10, wherein the controller dynamically adjusts current commands to the on-board charging module based on real-time monitoring of a load current of the AC load and an outlet status of an outlet of the vehicle.

16. The vehicle of claim 10, wherein the controller receives a current limit of the AC grid source via a control pilot line and limits total current from a charge port of the vehicle from exceeding the current limit to prevent the AC grid source from shutting down.

17. The vehicle of claim 10, wherein the output is a split-phase output offering access to both 120 Vac and 240 Vac.

18. The vehicle of claim 10, wherein the controller provides feedback to a human-machine interface to inform a user associated with the vehicle about a current power distribution status of the power electronics converter and the on-board charging module.

19. A system comprising:
a power electronics converter disposed in a vehicle, the power electronics converter to receive alternating current (AC) electrical power from an AC grid source and to provide AC electrical power to an AC load external to the vehicle;
an on-board charging module electrically connected to the power electronics converter and a battery disposed in the vehicle; and
a controller to control the power electronics converter and the on-board charging module based at least in part on a current limit of the AC grid source, an outlet status of an outlet of the vehicle, and load current information of the AC load,
wherein the power electronics converter provides vehicle-to-load functionality by providing, to the AC load, AC electric power as an output of at least one of a 120 Vac output or a 240 Vac output.

20. The system of claim 19, wherein the controller receives the current limit of the AC grid source via a control pilot line and limits total current from a charge port of the vehicle from exceeding the current limit to prevent the AC grid source from shutting down.
